(19) United States
(12) Patent Application Publication
(10) Pub. No.: US 2025/0131038 A1
(43) Pub. Date: Apr. 24, 2025

(54) MOTIF-BASED SUBGRAPH MATCHING IN PARTIALLY OBSERVED GRAPHS

(71) Applicant: Dell Products L.P., Round Rock, TX (US)

(72) Inventors: Diego Vrague Noble, Pelotas (BR); Eduardo Vera Sousa, Centro (BR); Karen Braga Enes, Belo Horizonte (BR); Karen Stéfany Martins, Belo Horizonte (BR)

(21) Appl. No.: 18/491,987

(22) Filed: Oct. 23, 2023

(51) Int. Cl. G06F 16/901; G06F 16/903; G06F 16/951

(52) U.S. Cl. CPC G06F 16/9024; G06F 16/90335; G06F 16/951

(57) ABSTRACT

A motif based approach for subgraph matching in partially observed graphs is disclosed. Graphlets are extracted from a query graph, such as a graph of a workload. Motifs are built from the graphlets and the motifs are matched to a target graph, such as an infrastructure graph. Once the motifs are matched to nodes in the target graph, tasks of the workload, which correspond to nodes in the query graph, are placed in the infrastructure for execution.

### FIELD OF THE INVENTION

Embodiments of the present invention generally relate to subgraph matching in partially observable graphs. More particularly, at least some embodiments of the invention relate to systems, hardware, software, computer-readable media, and methods for using motifs to perform subgraph matching in graphs including partially observed graphs.

### BACKGROUND

Subgraph matching is a classical NP-hard problem. Generally, subgraph matching is a process when an attempt is made to find occurrences of a particular pattern or a query subgraph in a target graph. Conventional subgraph matching techniques are useful in many applications. However, these techniques usually require an exhaustive search for all nodes of the graph. The complexity and difficulty of this subgraph matching process may depend on the size of the graph being searched, the size of the subgraph to find, and the available budget to query the target network.

The complexity of subgraph matching and the time and resources required to perform subgraph matching are significant and arise in a variety of applications including image datasets and document processing. Subgraph matching is a problem that can also arise in the context of placing workloads. A workload may include a set of tasks with hard and soft constraints. Workload placement solutions often attempt to find nodes in a network that are capable of executing the tasks of the workload.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a computing environment in which workloads are placed and aspects of an application or system configured to place workloads in the computing environment;

FIG. 2 discloses aspects of graphs including a workload modeled as a graph and a computing environment modeled as a graph;

FIG. 3 discloses aspects of an example method for placing workloads or workload tasks in a computing environment;

FIG. 4 discloses aspects of a query graph and a target graph;

FIG. 5 discloses aspects of a pipeline for placing workloads; and

FIG. 6 discloses aspects of a computing device, system or entity.

### DETAILED DESCRIPTION OF SOME EXAMPLE EMBODIMENTS

Embodiments of the present invention generally relate to subgraph matching. More particularly, at least some embodiments of the invention relate to systems, hardware, software, computer-readable media, and methods for subgraph matching for applications and scenarios including workload placement scenarios.

Embodiments of the invention create motifs to reduce the complexity of the subgraph to be found during a subgraph matching search. In one example, the subgraph matching problem is modeled as a partially observed graph search problem, such as selective harvesting. This reduces the complexity of the search and makes the task of finding matching subgraphs feasible for a wider and more complex range of workloads. Although embodiments of the invention are discussed in the context of placing workloads in a computing environment or system, any application (e.g., document processing, image searching) that relies on subgraph matching is within the scope of embodiments of the invention.

Embodiments of the invention include applying a motif-based crawling technique to decompose a workload, which may be represented as a graph or as a directed acyclic graph (DAG), into subgraphs. Graphlets (subgraphs) in the workload graph are crawled in an iterative seed-expansion process as a partially observed graph. Then, all graphlets are paired into motifs. In one example, the motifs may include recurrent and statistically significant patterns of a graph, i.e., subgraphs with semantic meaning. Decomposing the workload graph allows a subgraph matching technique to be applied on the resulting motifs, which are essentially smaller subgraphs of the original workload graph. Embodiments of the invention are able to perform or find graph matches more quickly, which compensates for the pre-processing requirements, reduced overprovisioning, lower executing time, reduced network strain, and improved resource usages. Using motifs does not require reliance on more intensive computational techniques and, consequently, allows the workload orchestrator to quickly adjust to network changes.

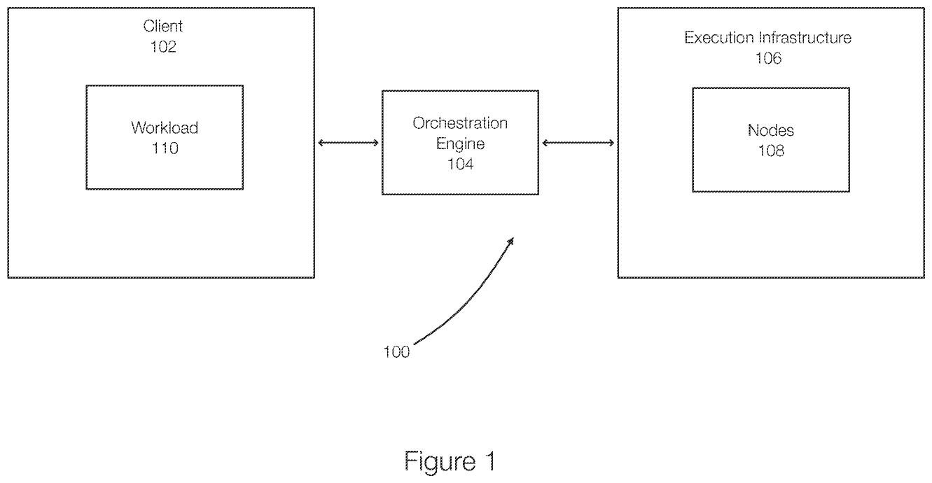

FIG. 1 discloses aspects of a computing environment or system in which workloads may be placed and executed. FIG. 1 illustrates a computing environment or execution infrastructure 106 that is configured to perform or execute workloads. An orchestration engine 104 may receive a workload 110 from a client 102 or customer. The orchestration engine 104 may place the workload 110 in one or more of the nodes 108 of the infrastructure 106 for execution. The infrastructure 106 may include a cloud environment, multiple cloud environments, or the like. The nodes 108 may include processors, memory, networking hardware, and the like. Results are then returned to the client 102.

In one example, the orchestration engine 104 is configured to perform a placement operation. The placement operation may include subgraph matching. The orchestration may perform subgraph matching in order to better place the workload in the nodes 108 of the infrastructure 106. More specifically, the orchestration engine 104 may split the workload 110, which is represented as a graph, into subgraphs that each represent a portion of the workload. Each node of the workload graph represents a task of the workload in one example. Motifs are determined from the subgraphs (or graphlets). This allows the target graph (the execution infrastructure 106) to be matched to the motifs. In effect, this process of matching the target graph to the motifs identifies the nodes of the infrastructure that will perform the tasks of the workload. The workload, or tasks, can then be placed at the identified nodes of the execution infrastructure 106.

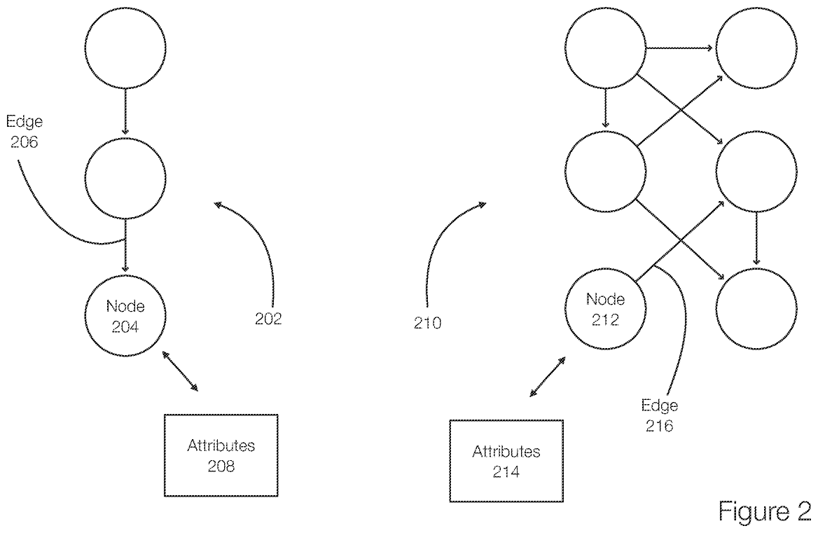

FIG. 2 discloses aspects of graphs in the context of workloads, computing systems, and workload placement. The graph 202 represents a workload. The workload may include various tasks that are represented as nodes and edges. Each of the nodes in the graph 202 may include or be associated with attributes and each node corresponds to a task of the workload. In one example, the attributes 208 of the node 204 include or represents requirements of the task associated with the node 204. Each edge, such as the directed edge 206, encodes a precedence relationship between the previous task and the next task of the workload. The edge 206 may also encode information about the network aspects, such as latency and bandwidth.

The infrastructure 106 may also be represented as a graph, such as the graph 210. The graph 210 includes nodes, such as the node 212, and edges, such as the edge 216. The nodes and edges may be associated with attributes. In one example, the attributes 214 of the node 212 may include features. The attributes 214 may include features such as infrastructure resources, which may include available memory, number of CPU (Central Processing Unit) cores, presence/absence of GPUs (Graphical Processing units), number of GPUs, and the like. The features of the attributes 214 may include topology information such as node centrality, which represents a topological importance of a node, a normalized degree, which represent a number of available neighbors, a component size, a clustering coefficient (e.g., local neighborhood density), or the like. The features of the attributes 214 may also include data availability, which identifies which datasets are available in each node. The edge 216 represents nodes that have a direct connection in the network and the edge 216 also encodes information about the network (i.e., between the connected nodes), such as latency and bandwidth.

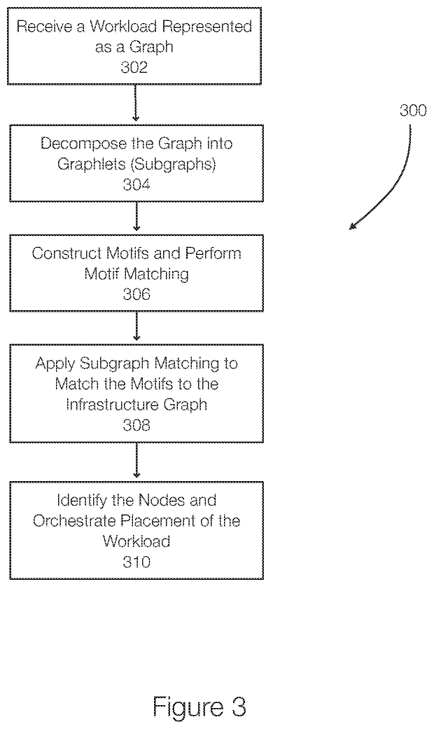

FIG. 3 discloses aspects of placing a workload using subgraph matching. In the method 300, a workload may be received 302 at an orchestration engine. The workload may be represented as a graph. If necessary, the workload may be converted to a graph representation.

In one example, a graph (e.g., a heterogeneous graph) that represents the infrastructure or network may be constructed. The graph may include nodes, edges, and attributes of nodes and edges. Each node may represent a specific infrastructure such as a machine, a virtual machine, a container, an edge system, or the like. Each node also includes attributes including infrastructure resources, topology information, and data availability. The edges represent direct connections between nodes in the network or infrastructure. Each edge may also encode information about the network such as latency and bandwidth.

A workload graph (a heterogeneous graph) may also be built or constructed. The workload graph includes nodes, edges, and attributes of the nodes and of the edges. Each node, in one example, represents a different task and each node has a set of attributes representing the requirements of the task, for example in terms of computing requirements. The directed edges encode a precedence relationship between the previous and next tasks and information about the network.

Once the network graph and the workload graph are constructed, embodiments of the invention may perform a workload placement operation. FIG. 3 discloses aspects of a placement operation. In the method 300, a workload is received 302 and represented as a graph. The workload is converted into a graph if necessary. The workload graph is then decomposed 304 into graphlets or subgraphs. By decomposing the workload graph, it may be possible to derive a large set of valid subgraphs that satisfy workload constraints and requirements. The workload graph may be decomposed, for example, using clustering techniques, cut-based methods, or the like. In one example, workloads may be represented as graphs where each node represents a task. Splitting this graph into subgraphs may depend on adopted criteria. For example, a subgraph may include tasks that are CPU-bound, depend on specific hardware, or the like.

Next, motifs are constructed and matched 306. More specifically, patterns are extracted from the set of subgraphs. These patterns, or motifs, are semantically richer than the subgraphs, and can be matched against nodes in the execution infrastructure in an efficient way compared to matching each of the subgraphs to nodes in the execution infrastructure. Thus, the motifs are matched to the known workload graph.

Next, a subgraph matching is performed or applied 308 to the set of motifs to find a match in the infrastructure graph. This subgraph matching process in the infrastructure graph identifies the nodes that will execute the tasks of the workload. Thus, the nodes of the infrastructure graph are identified and the orchestration engine places the workloads or tasks at the identified nodes.

Embodiments of the invention thus relate to a motif-based search in partially observed graphs.

### Searching in Graphs

Search in graphs refers to the process of traversing a graph, a subgraph or a set of interconnected nodes in order to find one or more specific nodes or paths in the graph. Graph search refers to a class of algorithms that systematically explore the nodes and edges of a graph and that may compute many interesting properties.

In many real networks, searching in a graph or accessing data associated with nodes and edges of the network is often difficult. The process is complicated by the cost of querying nodes. This is particularly true in very large networks. In these scenarios, a large fraction of the data to be modeled is unobserved and may not be queried because the budget for performing queries is limited. However, an entity that intends to search a graph may not be interested in searching the complete network, but in identifying a set of target nodes in the graph that have certain characteristics or attributes.

For example, consider the problem of finding as many Facebook users that share a particular taste in music as possible, starting from a specific user's friendship network. In this example, Facebook users are nodes, friendship status are edges and musical tastes are user attributes. Except for the Facebook engineers themselves, access to these networks is limited and it is impossible to query all of the nodes. It may be useful, however, to find a set of friends that have the desired characteristics, which can be achieved without searching the entire network or graph.

### Subgraph Matching

Considering a graph G and a query graph Q, the subgraph matching problem focuses on finding all subgraphs of G that are isomorphic to Q. The simplest way to solve this problem is through a brute-force search over all the subgraphs of G, but rarely used. More specifically, the number of possible subgraphs grows exponentially with the regards to the number of vertices and edges in G. Therefore, the subgraph matching problem is NP-complete. Employing heuristics is the most commonly used approach in several areas such as biology, transportation, and social science and is a traditional solution for workload placement. However, this is also difficult due to the cost of querying the network and the difficulty of solving an NP-complete problem.

### Selective Harvesting Problem

The problem of finding the largest number of target nodes for partially unknown or partially observed network topologies under a query budget constraint is called Selective Harvesting (SH). SH can be stated as a graph search problem on a partially unobserved network topology. However, due to the inherent complexity of the addressed problem, it can be framed from other perspectives, such as for example an unbalanced data classification problem, a reinforcement learning task or as an anomaly detection problem.

In SH, data is acquired through an online search or exploration of the graph, which can be seen as an evolving process that increases knowledge about the network as the search expands. At each step, structural and non-structural information regarding topology, nodes and edges' data is acquired. Because the networks are partially unobserved in SH, the set of queried nodes and their connections to the rest of the network compose all available information about the network.

Any algorithm that solves selective harvesting presents itself as a solution for a search problem into partially observed graphs. The main difference between these methods is how they choose which node of the graph to explore next.

One of the possible embodiments for the selective harvesting problem is referred to as the MCrawl Algorithm. The MCrawl Algorithm is composed of blocks that solves the Selective Harvesting problem in heterogeneous networks. The MCrawl algorithm is explained in C. Wang, K. C.-C. Chang, P. Wang, T. Qin and X. Guan, “Heterogeneous Network Crawling: Reaching Target Nodes by Motif-Guided Navigation,” IEEE Transactions on Knowledge and Data Engineering, vol. 34, no. 9, pp. 4285-4297, 2022 (hereinafter Wang), which is incorporated by reference in its entirety.

This algorithm can be understood as a heterogeneous crawling framework. The MCrawl algorithm performs a guided search in a partially observed heterogeneous network using a motif-based pattern approach. Motifs generalize the concept of link-based homophily—“close” nodes tend to be linked to each other—to heterogeneous networks by asserting that “close” nodes tend to link “in certain ways with those which are similar to them in particular ways”.

Overall, the framework operates iteratively by expanding the frontier of known nodes one node at a time. To decide which node is the best node to be incorporated from the frontier (and the best node to be queried), a complex semi-supervised probabilistic process of motif extraction, generation, and matching is performed. This iterative process continues while the query budget permits. Furthermore, The MCrawl algorithm requires an initial set of seed nodes from where the search is to be started.

There are five blocks responsible for finding the best node to expand the known network. These blocks are Frontier constructor, Motif guidance constructor, Harvest qualifier, Motif Qualifier, and Navigation qualifier.

From Wang, the blocks are described as:
Block 1) Frontier Constructor: This block mainly perform crawl and constructs the known region. At the beginning with only seed nodes as input, the known region is initialized by querying neighbors of seed nodes. At each crawling step, it updates the known region by receiving the best navigation from the navigation qualifier/The crawling iterates for a parameterized number of iterations.
Block 2) Motif Guidance Graph Constructor: To achieve motif guidance in crawling heterogeneous networks, this block takes the known region as input, and outputs a tripartite motif guidance graph between harvests, motif-based patterns and navigations.
Block 3) Harvest Qualifier: This block takes a motif guidance graph as input and outputs the quality of harvest w.r.t. our target interest.
Block 4) Motif Qualifier: This block takes motif guidance graph as input and outputs the quality of motifs w.r.t. our target interest.
Block 5) Navigation Qualifier: This block takes motif guidance graph as input and outputs the quality of navigations w.r.t. our target interest.

Blocks 1 and 2 compose the Motif-based crawling module while blocks 3, 4, and 5 compose the Harvest-motif-navigation co-qualification module. This second module is a probabilistic model that iteratively increases the likelihood of finding good motifs during the selective harvesting. Embodiments of the invention may incorporate aspects of this approach, but may also use other approaches that builds motifs and performs selective harvesting on graphs.

Embodiments of the invention address the problem of performing a subgraph matching task. A goal of this subgraph matching task is to check or determine whether a query graph Q is a subgraph of the target graph T.

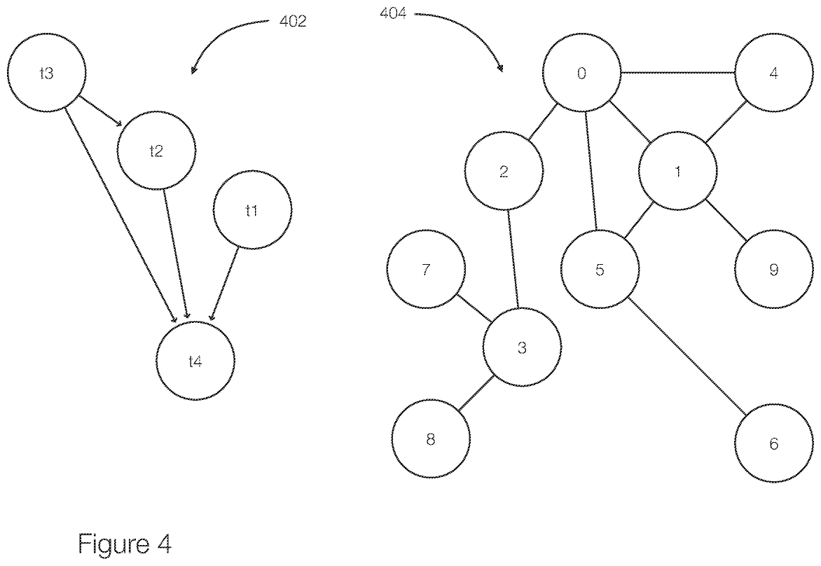

FIG. 4 discloses aspects of a query graph and a target graph. FIG. 3 illustrates a query graph 402 and a target graph 404. Embodiments of the invention partition the graph into small portions with similar properties (motifs) and perform the patch between the motifs. Embodiments of the invention partition the query graph into small portions with similar properties (a.k.a. motifs) and perform matching between the motifs. Partitioning provides some advantages that include: (i) reduced matching complexity, because the number of nodes in a motif is considerably smaller than the number of nodes in the entire graph; and (ii) the possibility of parallelization for the matching process. Embodiments of the invention may define or determine which node of target graph T corresponds to each node of the query graph Q while considering the edge between them.

In a workload placement context, for example, this corresponds to finding the information to determine which infrastructure node is more suitable for running a task or a workload considering not only the resource availability at this node but also the network connections between the infrastructure nodes. In one example, embodiments of the invention do not necessarily focus on finding the optimal subgraph (or nodes) to run a workload, because matching with this type of constraint is an NP-complete problem. Rather, embodiments of the invention focus on finding at least one subgraph of T that is able to run workloads while coping with the requirements of the workloads.

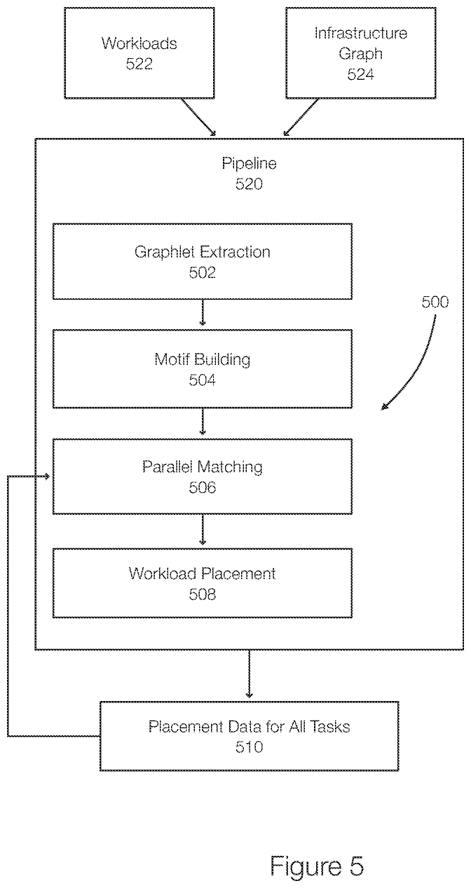

FIG. 5 discloses aspects of placing workloads. More specifically, FIG. 5 illustrates an example of a pipeline for motif-based subgraph matching and illustrates an example method for placing workloads in an infrastructure. The pipeline may be configured to perform the method 500.

In one example, an infrastructure graph (which may be partially unobservable) 524 and workloads 522 may be input to a pipeline 520. More specifically, a set of workloads {wᵢ}ᵢ₌₀ⁿ to be deployed in an infrastructure T may be received by a pipeline 520, which may be an example of an orchestration engine. These workloads 522 and the infrastructure graph 524 are examples of input to the pipeline 522.

Each workload wᵢ includes a set of tasks tₘ^{(w}^{ᵢ}⁾ represented by nodes in the workload graph and the dependency between the tasks is represented by the edges between these nodes. The expected output of the pipeline 520 may be a placement plan for each task {tⱼ}ⱼ₌₀^{m} of wᵢ, represented as {tⱼ^{(w}^{ᵢ}⁾}ⱼ₌₀^{m}. The pipeline 520 processes each of the n workloads in the method 500. The n workloads may be processed serially or in parallel or in another order.

Initially, graphlet extraction 502 is performed. In graphlet extraction 502, a workload, which is represented as a workload graph, is split into graphlets or subgraphs. Each node of a graphlet (i.e., each task of the workload) contains information about the resource requirements of the task in terms of, by way of example, RAM, CPU, disk usage, or the like.

Next, motif building 504 is performed. The graphlet extraction 502 generated graphlets that share relevant patterns, such as network latency, task dependency relationships, frequency of execution, and the like. These patterns are used to build the motifs. In effect, the motifs are new graphs that are built upon graphlets, clustered and filtered in terms of patterns (e.g., network latencies smaller than 60 milliseconds). Graphlets aggregated and attached with a semantic meaning derived from the patterns are an example of motifs. Building motifs allows classification to be performed on the nodes of the target graph, which is an example of a selective harvesting based approach.

Once the motifs are constructed, parallel matching 506 is performed. Because motifs from the query graph are available, a selective harvesting search process may be performed on the target graph in order to find similarities with the motif (e.g., subgraphs that are similar to the motif). In general, selective harvesting relies on a search process that classifies nodes incrementally, according to a budget using exploration-exploitation paradigm such that all nodes of the target graph are not required to be checked. This is significant in the context of large infrastructures. The classification is performed using the motifs or motif patterns previously determined. For example, embodiments of the invention may check, for each node, whether the node is able to cope with the requirements imposed by the motif's patterns. The selective harvesting approach guides the process of discovering nodes towards a region with higher probability of coping with the requirements of the motif's patterns.

Advantageously, selective harvesting can be applied in parallel because the motifs associated with the query graph are independent of each other. This reduces the complexity compared to other subgraph matching operations, such as feature matching, where each node from query and each node from target must be compared.

Once the motifs are matched by classifying the nodes obtained from the selective harvesting operations, the query graph and the target graph can be matched. The output of matching the query and target graphs is a list of tuples. The first element of each tuple is the task of the workload wᵢ and the second node is the node where the task is allocated.

The placement data 510 for the tasks allows the availability of resources in the target graph, which is used in parallel matching 506, and allows the placement plan to be optimized. More specifically, as nodes are allocated, the attributes of the node may be updated when considering the node for other tasks of a workload.

Embodiments of the invention may also be applied to other applications other than workload placement. For example, embodiments of the invention may be used to retrieve data from an image database where the goal is to find a subgraph from the target that is similar to the query graph given a metric of similarity. This may be used for images in the context of geo-localization and the like.

Embodiments of the invention can be adapted to retrieving data (e.g., specific images) from an image database, where it is necessary to find a subgraph from the target graph that is similar to the query graph given a metric of similarity. The image database is an example of a target graph and an image is an example of a query graph. Embodiments of the invention can also be used in document processing. For example, embodiments of the invention may be used for searching specific symbols in graphical documents.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, searching operations, subgraph searching operations, graph related operations, workload placement operations, image searching operations, subgraph matching operations, document processing operations, or the like. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data storage functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment.

Example embodiments of the invention are applicable to any system capable of storing and handling various types of objects or data, in analog, digital, or other form.

It is noted with respect to the disclosed methods, that that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: decomposing a query graph into a set of graphlets, wherein the query graph corresponds to a workload, building motifs based on the set of graphlets obtained from the query graph, performing a search in a target graph using the motifs to match nodes of the query graph to nodes of the target graph, wherein the target graph corresponds to a computing network, each node of the target graph corresponds to node in the computing network, and each node of the query graph corresponds to a task of a workload, and placing tasks of the workload at the matched nodes of the target graph.

Embodiment 2. The method of embodiment 1, wherein the query graph comprises a workload graph.

Embodiment 3. The method of embodiment 1 and/or 2, wherein at least some of the graphlets in the set of graphlets share patterns, wherein the motifs are built based on the patterns.

Embodiment 4. The method of embodiment 1, 2, and/or 3, further comprising clustering and filtering the graphlets to identify the patterns.

Embodiment 5. The method of embodiment 1, 2, 3, and/or 4, wherein the patterns include one or more of network latency, task dependency relationship, frequency of execution, and/or computing requirements.

Embodiment 6. The method of embodiment 1, 2, 3, 4, and/or 5, further comprising performing selective harvesting in the target graph.

Embodiment 7. The method of embodiment 1, 2, 3, 4, 5, and/or 6, further comprising performing the selective harvesting for all of the motifs in parallel.

Embodiment 8. The method of embodiment 1, 2, 3, 4, 5, 6, and/or 7, further comprising matching the motifs to the target graph, wherein nodes in the computing network matching the motifs are capable of coping with requirements of tasks of the workload set forth in the motifs.

Embodiment 9. The method of embodiment 1, 2, 3, 4, 5, 6, 7, and/or 8, further comprising performing the tasks of one or more workloads at nodes in the computing network.

Embodiment 10. The method of embodiment 1, 2, 3, 4, 5, 6, 7, 8, and/or 9, further comprising updating the matching of the motifs by updating an availability of resources in the target graph.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, client, agent, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

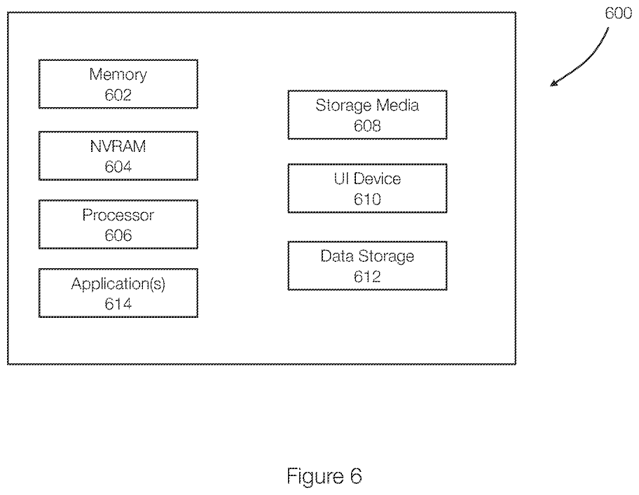

With reference briefly now to FIG. 6, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The device 700 may also represent a node, an edge environment with multiple nodes, a cloud environment, or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
decomposing a query graph into a set of graphlets, wherein the query graph corresponds to a workload;
building motifs based on the set of graphlets obtained from the query graph;
performing a search in a target graph using the motifs to match nodes of the query graph to nodes of the target graph, wherein the target graph corresponds to a computing network, each node of the target graph corresponds to node in the computing network, and each node of the query graph corresponds to a task of a workload; and
placing tasks of the workload at the matched nodes of the target graph.

2. The method of claim 1, wherein the query graph comprises a workload graph.

3. The method of claim 1, wherein at least some of the graphlets in the set of graphlets share patterns, wherein the motifs are built based on the patterns.

4. The method of claim 3, further comprising clustering and filtering the graphlets to identify the patterns.

5. The method of claim 4, wherein the patterns include one or more of network latency, task dependency relationship, frequency of execution, and/or computing requirements.

6. The method of claim 1, further comprising performing selective harvesting in the target graph.

7. The method of claim 6, further comprising performing the selective harvesting for all of the motifs in parallel.

8. The method of claim 6, further comprising matching the motifs to the target graph, wherein nodes in the computing network matching the motifs are capable of coping with requirements of tasks of the workload set forth in the motifs.

9. The method of claim 1, further comprising performing the tasks of one or more workloads at nodes in the computing network.

10. The method of claim 1, further comprising updating the matching of the motifs by updating an availability of resources in the target graph.

11. A non-transitory storage medium having stored therein instructions that are executable by one or more hardware processors to perform operations comprising:
decomposing a query graph into a set of graphlets, wherein the query graph corresponds to a workload;
building motifs based on the set of graphlets obtained from the query graph;
performing a search in a target graph using the motifs to match nodes of the query graph to nodes of the target graph, wherein the target graph corresponds to a computing network, each node of the target graph corresponds to node in the computing network, and each node of the query graph corresponds to a task of a workload; and
placing tasks of the workload at the matched nodes of the target graph.

12. The non-transitory storage medium of claim 11, wherein the query graph comprises a workload graph.

13. The non-transitory storage medium of claim 11, wherein at least some of the graphlets in the set of graphlets share patterns, wherein the motifs are built based on the patterns.

14. The non-transitory storage medium of claim 13, further comprising clustering and filtering the graphlets to identify the patterns.

15. The non-transitory storage medium of claim 14, wherein the patterns include one or more of network latency, task dependency relationship, frequency of execution, and/or computing requirements.

16. The non-transitory storage medium of claim 11, further comprising performing selective harvesting in the target graph.

17. The non-transitory storage medium of claim 16, further comprising performing the selective harvesting for all of the motifs in parallel.

18. The non-transitory storage medium of claim 16, further comprising matching the motifs to the target graph, wherein nodes in the computing network matching the motifs are capable of coping with requirements of tasks of the workload set forth in the motifs.

19. The non-transitory storage medium of claim 11, further comprising performing the tasks of one or more workloads at nodes in the computing network.

20. The non-transitory storage medium of claim 11, further comprising updating the matching of the motifs by updating an availability of resources in the target graph.
